(19) United States
(12) Patent Application Publication
(10) Pub. No.: US 2006/0116460 A1
(43) Pub. Date: Jun. 1, 2006

(54) Rubber composition which can be used to form a sealing strip, a process for the preparation of this composition and such a sealing strip

(75) Inventors: Pierre Georget, Girolles (FR); Aline Beaudelet, La Norville (FR); Domitille Tregouet, Saint Germain En Laye (FR)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Hutchinson

(21) Appl. No.: 11/284,934

(22) Filed: Nov. 22, 2005

(30) Foreign Application Priority Data
Nov. 26, 2004 (FR) 0412569

(51) Int. Cl. C08C 19/00; C08K 5/09

(52) U.S. Cl. 524/394; 525/383

(57) ABSTRACT

The present invention relates to a rubber composition which can be used to form a sealing strip, a process for the preparation of this composition and such a sealing strip. The composition according to the invention, which can be used to form, in the crosslinked state, a sealing strip exhibiting a non-tacky surface and a reduced compression set, is based on at least one elastomer and comprises a crosslinking system comprising at least one organic peroxide. According to the invention, this composition comprises: (pce: parts by weight per 100 parts of elastomer(s)) at least one first organic salt of at least one transition metal chosen from the group consisting of manganese, iron, cerium and vanandium, according to an amount equal to or greater than 2 pce, and at least one second organic salt of at least one other metal chosen from the group consisting of zinc, zirconium, lithium, calcium and barium, according to an amount equal to or greater than 2 pce.

The present invention relates to a rubber composition which is usable to form a sealing strip, a process for the preparation of this composition and such a sealing strip. The invention also applies to sealing strips or profiles for the insulation of buildings or motor vehicles.

Sealing strips are conventionally formed from rubber compositions which have been specifically crosslinked with sulphur in a hot air atmosphere. This is because, if an attempt is made to crosslink these rubber compositions in hot air (typically in an oven at a temperature of the order of 200° C.) using a crosslinking system comprising an organic peroxide, experience shows that the crosslinked compositions obtained exhibit an tacky or sticky external surface owing to the fact that the oxygen in the air limits the crosslinking by reacting with the radical chemical entities formed during the decomposition of this peroxide, and this tacky surface, which is only partially cured, does not make it possible to use these compositions in forming sealing strips.

This is the reason why the crosslinking of these rubber compositions by organic peroxides is generally carried out using relatively complex and expensive devices, such as baths of molten salts.

The Patent document U.S. Pat. No. 4 334 043 presents a process for the crosslinking of rubber compositions via an organic peroxide which is carried out in a hot air atmosphere and which is nevertheless designed to confer a relatively non-tacky surface on these compositions. This process consists in treating these compositions, before the crosslinking thereof, using a treatment agent which is chosen from the group consisting of an organometallic compound obtained by reaction of an aliphatic or aromatic acid with a transition element of the Periodic Table, of salts of inorganic acids of transition elements, of a lanthanide compound and of mixtures of these compounds.

The implementational examples of this document indicate that the treatment agents which provide the least tacky surfaces, with reference to four degrees of tacky nature given material formed by the intensity of impressions of the samples on paper, are one or other of the following salts, incorporated in isolation and always in solution in xylene:

cobalt octoate, manganese octoate, iron octoate, zirconium iron octoate, nickel octoate or cerium octoate.

It should be noted that this document does not relate to rubber compositions for sealing strips. In addition, it should be noted that the tests used in this document exhibit the disadvantage of being tainted by a lack of precision in the determination of a sample surface entirely devoid of a tacky nature, owing to the fact that these impression tests are solely visual and give rise to only four degrees of tacky nature ranging from a tacky surface (+++) to a surface of reduced tack (−−−).

Furthermore, another disadvantage of the process disclosed in this document is that the treatment agents tested necessarily have to be incorporated in the rubber composition in the solution form and solely at the surface (by spraying or coating) in order to confer, on the latter, a reduced tack of level (−−−) in the crosslinked state, which complicates the implementation of the process and thus increases its operating cost. Furthermore, the solvents used, which are sources of volatile organic compounds, may exhibit a degree of toxicity and it should additionally be noted that their incorporation in the rubber composition by mixing and not at the surface is capable of generating undesirable bubbles in the composition finally obtained owing to the fact that the crosslinking is carried out without application of pressure.

A purpose of the present invention is to overcome these disadvantages and this purpose is achieved in that the Applicant has just discovered, surprisingly, that the incorporation in a rubber composition based on at least one elastomer:
of at least one first organic salt of at least one transition metal chosen from the group consisting of manganese, iron, cerium and vanadium, according to an amount equal to or greater than 2 pce, and
of at least one second organic salt of at least one other metal chosen from the group consisting of zinc, zirconium, lithium, calcium and barium, according to an amount equal to or greater than 2 pce,
   makes it possible, following crosslinking of this composition in hot air by a crosslinking system comprising at least one organic peroxide, to obtain a crosslinked rubber composition which is usable to form a sealing strip exhibiting a truly non-tacky surface and a reduced compression set (CS).

In the present description, the abbreviation “pce” denotes, in a known way, the parts by weight per 100 parts of elastomer(s) in the said rubber composition.

The expression “composition based on” should be understood as meaning a composition comprising the mixture and/or the product of in situ reaction of the various constituents used, it being possible for some of these compounds to react with one another during the various phases of preparation of the composition.

It should be noted that this non-tacky surface and this reduced CS which are obtained following the crosslinking in hot air of the said composition by the said peroxide testify to an unexpected synergistic effect which exists between the said first and second organic salts, in comparison with the sole use of a first organic salt according to the invention, such as a manganese, iron, or nickel salt, after the fashion of the salts tested in the document U.S. Pat. No. 4 334 043.

Mention may be made, as elastomer(s) which can be used in the composition according to the invention, of any diene or non-diene elastomer which can be crosslinked by an organic peroxide and which is suitable for forming the elastomer matrix of compositions for sealing strips.

Preferably, the said or one at least of the said elastomer(s) is a copolymer of ethylene and of propylene or else a terpolymer of ethylene, of propylene and of a diene (EPDM) and, more preferably still, the said or each elastomer used in the composition according to the invention is a terpolymer of ethylene, of propylene and of ethylidenenorbornene.

Advantageously, the said or each first salt and the said or each second salt are each independently a salt of a monocarboxylic or dicarboxylic acid of saturated or unsaturated aliphatic type, of alicyclic type or of aromatic type comprising one or more unsubstituted or substituted aromatic rings.

More advantageously still, the said or each first salt and/or the said or each second salt result from identical or different saturated aliphatic monocarboxylic acids, such as acetic acid, 2-ethylhexanoic acid and stearic acid.

According to a preferred implementational example of the invention, the said or each first salt and/or the said or each second salt result from 2-ethylhexanoic acid.

According to another implementational example of the invention, the said or each first salt and/or the said or each second salt result from identical or different monocarboxylic acids of alicyclic type, such as naphthenic acid.

Advantageously, the composition according to the invention comprises a manganese salt as first salt.

Also advantageously, the composition according to the invention comprises a zinc salt and/or a zirconium salt as second salt(s).

More advantageously still, the composition according to the invention comprises, in combination, a manganese salt, such as manganese 2-ethylhexanoate, and a zinc salt, such as zinc 2-ethylhexanoate.

Preferably, the composition according to the invention comprises the said first salt(s) according to an amount equal to or greater than 4 pce and the said second salt(s) according to an amount equal to or greater than 3 pce and, more preferably still, the said composition comprises manganese 2-ethylhexanoate according to an amount ranging from 4 to 8 pce and zinc 2-ethylhexanoate according to an amount ranging from 3 to 6 pce.

According to another advantageous characteristic of the invention, the said composition comprises the said organic peroxide according to an amount of active product equal to or greater than 2.8 pce, the said peroxide corresponding to the general formula ROOR in which R is an aliphatic hydrocarbon radical, an alicyclic hydrocarbon radical or an aromatic hydrocarbon radical which is unsubstituted or substituted.

Mention may for example be made, as organic peroxide which can be used in the composition according to the invention, without implied limitation, of a dispersion in an elastomer, such as a copolymer of ethylene and of propylene (EPM), or in an inorganic medium of chalk or silica type of a peroxide chosen from the group consisting of 1,3-1,4-bis(tert-butylperoxyisopropyl)-benzene, di(2-tert-butylisopropyl)benzene peroxide, dicumyl peroxide and 1,1-di(tert-butylperoxy)-3,3,5-trimethylcyclohexane.

Advantageously, the said system for crosslinking the composition according to the invention additionally comprises triallyl cyanurate according to an amount ranging from 2 to 4 pce and trimethylolpropane trimethacrylate according to an amount ranging from 1 to 3 pce.

According to another characteristic of the invention, the said composition additionally comprises a reinforcing filler according to an amount of greater than 100 pce and preferably of greater than 130 pce, this reinforcing filler advantageously being based on a carbon black, such as a black of grade 500 to 700.

It should be noted that the compositions in accordance with the invention also comprise, in addition to the said elastomer(s), the said organometallic salts, the said crosslinking system and the said reinforcing filler, all or part of the other ingredients commonly used in sealing strips, such as, without implied limitation, diluting light-coloured fillers, plasticizers, drying agents or extending oils.

According to another advantageous characteristic of the invention, the said composition exhibits, in the crosslinked state, a compression set (CS in %), measured according to Standard NF T46-011, which is less than or equal to 30% and more advantageously still which is less than or equal to 20%, in comparison with the known compositions crosslinked with sulphur for sealing strips, which usually exhibit a CS, measured according to the same standard, of at least 50%.

The result of this is that the sealing strips according to the invention, which are formed from the said composition and which can be used in particular for the insulation of buildings or motor vehicles, exhibit reduced dimensions in comparison with those of the known strips crosslinked with sulphur for the achievement of the same predetermined CS. It should be noted that, for the same geometric profile, the strips according to the invention exhibit an improved sealing capability in comparison with that of these known strips.

A process for the preparation according to the invention of the said rubber composition comprises the incorporation in the said crosslinkable composition of the said first and second salt(s) by mechanical working, followed by crosslinking the said composition with hot air.

According to another advantageous characteristic of the invention, this process comprises the in situ mixing of the said first and second salt(s) during their incorporation in the said crosslinkable composition.

The abovementioned characteristics of the present invention, and others, will be better understood on reading the following description of several implementational examples of the invention, given by way of illustration and without implied limitation.

In the examples which follow, the properties of the compositions of the invention are evaluated as follows:
In the noncrosslinked state, the following properties were measured:
   Mooney viscosity ML(1+4) at 100° C.: according to Standard ISO 289-1,
   scorch time t5 (min) at 125° C.: according to Standard ISO 289-2.
During the crosslinking, the following rheometric properties of the compositions were measured using a rotorless MDR rheometer at 170° C., according to Standard ASTM D 6204:
   minimum torque ML (dN.m),
   maximum torque MH (dN.m),
   the difference ΔC=MH−ML (dN.m), and
   the times t′c(05), t′c(50) and t′c(95) in min.
   In the crosslinked state, the following physical properties were measured on test specimens prepared according to Standard NF T 46-001:
   density: according to Standard ISO 2781,
   Shore A hardness: according to Standard NF T 46-003,
   rebound resilience (energy return by rebound, standardized to 100): according to Standard ISO 4662,
   compression set (CS in %): according to Standard NF T 46-011,
   tensile strength measurements on test specimens of dumbbell type comprising the breaking strength (BS in MPa), the elongation at break (EB in %) and the apparent secant moduli of elongation (MPa) at 100% and 300% elongation (SMOE 100 and SMOE 300): according to Standard NF T 46-002,
   tear strength (in N/mm): on Delft test specimens according to Standard NF T 46-039.

### EXAMPLES

I/ First Series of Tests:

Two “control” rubber compositions C1 and C2, which are respectively crosslinked with sulphur and by an organic peroxide, two rubber compositions NA1 and NA2 not in accordance with the invention, both crosslinked by this peroxide, and a rubber composition I1 according to the invention, also crosslinked by this peroxide, were prepared. These compositions are suitable for a sealing strip for a motor vehicle door seal.

The compositions C1 and C2 each exhibit the following formulation (expressed in pce: parts by weight per 100 parts of elastomers):

| | |
|---|---|
| Elastomers (1) | 100.00 |
| Extending oil | 12.90 |
| Carbon black | 94.00 |
| Reinforcing light-coloured filler (2) | 40.10 |
| Diluting light-coloured filler | 49.90 |
| Paraffin plasticizer | 33.90 |
| Polyethylene glycol | 2.40 |
| Stearic acid | 1.40 |
| Drying agent (3) | 6.40 |
| Crosslinking system (4) | variable |

with
(1) = blend of three terpolymers of ethylene, of
propylene and of ethylidenenorbornene (EDPM),
including: 8 pce of an EPDM, the levels by weight of ethylene
and of diene of which are respectively 57.5% and 4.7%,
69.90 of an EPDM, the levels by weight of ethylene
and of diene of which are respectively 55.5% and
5.7%, and
35 pce of an EPDM extended with 75% of oil, the
respective levels by weight of ethylene and of
diene of which are 55% and 4%;
(2): mixture of quartz and of kaolinite;
(3): calcium oxide on support; and
(4): for the composition C1:
a sulphur crosslinking system comprising (pce):

| | |
|---|---|
| Zinc oxide | 9.10 |
| 70% Tetramethylthiuram disulphide | 1.10 |
| 70% Tetramethylenethiuram tetrasulphide | 1.10 |
| 75% Mercaptobenzothiazole | 0.43 |
| 70% Benzothiazyl disulphide | 1.50 |
| 80% Sulphur, 120 mesh | 1.70 |
| 80% Dithiodicaprolactam | 2.00 |

for the composition C2:
a peroxide crosslinking system comprising 8 pce of
“Luperox F 40 MF”, i.e. a dispersion comprising
40% by weight of 1,3-1,4-bis(tert-
butylperoxyisopropyl)benzene as active product.

The composition NA1 differs from the composition C2 only in that it additionally comprises 4 pce of zinc octoate, which is diluted in a paraffin plasticizer and which is sold by Vanderbilt under the name “Octoate Z” (the fraction by weight of active product in this dilution is close to 80%).

The composition NA2 differs from this composition C2 only in that it additionally comprises 4 pce of manganese octoate, which is diluted in a paraffin plasticizer and which is sold by Borchers under the name “Octa Soligen Manganese 10 HS” (the fraction by weight of active product in this dilution is close to 64%, i.e. approximately 10% of manganese metal).

The composition I1 according to the invention differs from this composition C2 only in that it additionally comprises 4 pce of this manganese octoate combined in situ with 4 pce of this zinc octoate.

Each composition was prepared in two steps. In a first step, carried out in an internal mixer via two rotors rotating in opposite directions at 60 rev/min, and at 30° C., the ingredients of each composition, with the exception of the crosslinking system, were introduced and mixed. In a second step, carried out in an external mixer using two rolls rotating in opposite directions at 40° C., the corresponding crosslinking system was incorporated in each composition and each crosslinkable composition thus obtained was worked mechanically for approximately 20 min.

For the purpose of evaluating the tack of each rubber composition in the crosslinked state, each composition thus obtained by mixing and mechanical working was shaped in the form of a tubular section using a screw extruder provided with an annular die and then each extruded section was crosslinked in an oven at 220° C. for 5 min. After having cooled each crosslinked section thus obtained, tactile and auditory tests were carried out on the latter in order to evaluate its tack.

This evaluation of the tack was carried out by assigning a level of tack for each section ranging from 0 to 10, where 0 corresponds to the tacky surface which characterizes the composition C2 crosslinked with peroxide and where 10 corresponds, on the other hand, to the truly non-tacky surface which normally characterizes the composition C1 crosslinked with sulphur. In a first test, an operator applied his fingers to the external face of the cylindrical wall of each crosslinked section, in order to deduce therefrom a first tactile evaluation of the tack of the section. In a second more precise test, the operator manually exerted a radial compressive force on each section (i.e. perpendicularly to its cylindrical wall) and then he visually evaluated the ability of the section to return to its initial state after having stopped exerting this compressive force.

For the purpose of measuring the physical properties of each composition in the crosslinked state, each composition obtained by mixing and mechanical working was shaped and crosslinked in the form of a plaque by moulding in a compression. This moulding machine was heated while placing it under a pressure of 100 bar and then the crosslinking was carried out by curing each composition, placed inside the mould of the machine, up to a time t′c(95), determined by the rheometer, which corresponds to 95% of the complete crosslinking. The heating temperature, which is that set during the measurement of this time t′c(95), brings about immediate flow of each composition. Venting is carried out at regular time intervals during the pressurization, in order to avoid any presence of bubbles in the mixture. Following the crosslinking thus obtained, the crosslinked plaque, formed from the corresponding rubber composition, is removed manually.

The properties obtained in the noncrosslinked state, during the crosslinking and in the crosslinked state for each rubber composition C1, C2, NA1, NA2 and I1 are recorded in Table 1 below.

TABLE 1

| | | | | |
|---|---|---|---|---|
| C1 | C2 | NA1 | NA2 | I1 |

Mooney viscometry

| | | | | | |
|---|---|---|---|---|---|
| ML(1 + 4) | 82.6 | 83.8 | 83.0 | 91.2 | 90.0 |
| t5 scorch (min) | >30 | 9.97 | 11.13 | 9.97 | 9.88 |

MDR rheometer at 170° C.

| | | | | | |
|---|---|---|---|---|---|
| ML (dN.m) | 2.23 | 2.53 | 2.32 | 2.47 | 2.33 |
| MH (dN.m) | 20.92 | 16.47 | 15.93 | 16.93 | 14.57 |
| ΔC (dN.m) | 18.69 | 13.94 | 13.60 | 14.45 | 12.24 |
| t′c(05)(min) | 1.88 | 0.52 | 0.52 | 0.56 | 0.57 |
| t′c(50)(min) | 3.37 | 3.05 | 2.75 | 3.53 | 2.80 |
| t′c(95)(min) | 14.63 | 12.78 | 11.07 | 16.32 | 14.38 |

Physical properties

| | | | | | |
|---|---|---|---|---|---|
| Tack | 10 | 0 | 0 | 8 | 10 |
| Density | 1.32 | 1.29 | 1.28 | 1.28 | 1.28 |
| Shore A | 69 | 61 | 61 | 62 | 61 |
| Resilience | 50.6 | 49.4 | 49.0 | 48.8 | 48.6 |
| CS (%) | 58 | 21 | 18 | 20 | 19 |
| SMOE 100 (MPa) | 4.2 | 3.0 | 3.0 | 3.0 | 3.0 |
| SMOE 300 (MPa) | 9.2 | 8.7 | 8.6 | 9.6 | — |
| BS (MPa) | 9.8 | 9.1 | 9.7 | 10.5 | 7.5 |
| EB (%) | 321 | 301 | 307 | 323 | 246 |
| Tear strength (N/mm) | 15.66 | 14.07 | 13.68 | 14.31 | 13.95 |

It will be noted that the combination of a first organic salt and of a second organic salt according to the invention (respectively of manganese and of zinc) surprisingly confers, on the section formed from the composition I1 according to the invention, a truly non-tacky surface (level of tack equal to 10), after the fashion of the reference surface which characterizes the section formed from the composition C1 crosslinked with sulphur and in contrast to the section formed from the composition C2 crosslinked with peroxide, the surface of which is very tacky (level of tack equal to 0), while conferring, on this composition I1, a CS which is markedly minimized with respect to that of this composition C1, after the fashion of the reference CS which characterizes the composition C2 crosslinked with peroxide.

It will be noted in particular that the synergistic effect of this combination of organic salts of manganese and of zinc is illustrated by the fact that the zinc salt incorporated in the composition NA1 does not make it possible to reduce, by itself alone, the tack of the section and that the manganese salt confers, on the section formed from the composition NA2, a surface which is still somewhat tacky in comparison with that of the section formed from the composition I1, which is not at all tacky (see the significant difference at 20% which exists between the tack of the compositions NA2 and I1).

II/ Second Series of Tests

Again a composition C1 as described in § I/ above, three compositions NA3, NA4 and NA5 not in accordance with the invention and three compositions I2, I3 and I4 according to the invention were prepared. These compositions NA3 to NA5 and I2 to I4 are all crosslinked by the same peroxide as the composition C2 described in § I/ and they incorporate, in addition to the ingredients of the composition C2, combinations of organic salts of metals and a crosslinking co-agent for increasing the hardness of the compositions.

The formulations of the compositions NA3 to NA5 and I2 to I4 are shown below, in comparison with that of the composition C2:
NA3=C2+1 pce manganese octoate+2 pce zinc octoate+1 pce TAC
NA4=C2+1 pce manganese octoate+2 pce zirconium octoate+2 pce TAC
NA5=C2+1 pce manganese octoate+2 pce strontium octoate+4 pce TAC
I2=C2+2 pce manganese octoate+2 pce zinc octoate+2 pce TAC
I3=C2+4 pce manganese octoate+2 pce zinc octoate+4 pce TAC
I4=C2+4 pce manganese octoate+2 pce zirconium octoate+1 pce TAC

Manganese octoate and zinc octoate: identical to those tested in § I/ above,

Zirconium octoate: diluted in a paraffin plasticizer and sold by Borchers under the name “Octoate Soligen 18 HS” (the fraction by weight of active product in this dilution is close to 69%), Strontium octoate: diluted in a paraffin plasticizer and sold by Borchers under the name “Octoate Soligen Strontium 10 HS” (the fraction by weight of active product in this dilution is close to 44%), and TAC=triallyl cyanurate (crosslinking co-agent) with the trade name “TAC 70 GR”.

Each crosslinked composition was prepared and analysed as indicated in § I/. The properties obtained in the noncrosslinked state, during the crosslinking and in the crosslinked state for each rubber composition C1, NA3 to NA5 and I2 to I4 are recorded in Table 2 below.

TABLE 2

| | C1 | NA3 | NA4 | NA5 | I2 | I3 | I4 |
|---|---|---|---|---|---|---|---|
| ML(1 + 4) | 83.6 | 82.6 | 82.7 | 81.4 | 81.7 | 76.4 | 83.0 |
| t5 scorch (min) | >30 | 13.88 | 13.17 | 17.58 | 18.80 | 22.30 | 12.08 |
| ML (dN.m) | 2.08 | 2.05 | 2.18 | 2.17 | 2.03 | 1.79 | 2.01 |
| MH (dN.m) | 20.42 | 17.53 | 21.03 | 23.46 | 18.58 | 19.30 | 13.12 |
| ΔC (dN.m) | 18.34 | 15.48 | 18.86 | 21.29 | 16.55 | 17.50 | 11.11 |
| t′c(05)(min) | 1.80 | 0.62 | 0.65 | 0.72 | 0.68 | 0.83 | 0.60 |
| t′c(50)(min) | 3.35 | 3.25 | 3.38 | 3.67 | 3.65 | 4.23 | 3.28 |
| t′c(95)(min) | 16.38 | 12.73 | 12.73 | 13.70 | 13.57 | 15.08 | 13.38 |
| Tack | 10 | 7 | 6 | 5 | 10 | 10 | 10 |
| Shore A | 69 | 63 | 65 | 67 | 64 | 65 | 63 |
| CS (%) | 54 | 19 | 12 | 13 | 13 | 13 | 18 |
| SMOE 100 (MPa) | 4.1 | 3.2 | 4.0 | 5.0 | 3.7 | 3.9 | 2.7 |
| SMOE 300 (MPa) | 9.3 | 10.3 | — | — | — | — | 7.9 |
| BS (MPa) | 9.9 | 10.0 | 10.4 | 10.1 | 10.1 | 9.6 | 9.0 |
| EB (%) | 324 | 293 | 256 | 202 | 258 | 227 | 328 |
| Tear strength (N/mm) | 14.20 | 13.71 | 13.39 | 13.08 | 12.86 | 12.09 | 14.31 |

This table shows that the combination of at least 2 pce of a manganese salt, as first salt according to the invention, and of 2 pce of a zinc or zirconium salt, as second salt according to the invention, confers, on the sections respectively formed from the compositions I2 to I4, a truly non-tacky surface (level of tack equal to 10), after the fashion of the surface which characterizes the section formed from the composition C1 crosslinked with sulphur, while conferring, on these compositions I2 to I4, a CS which is markedly minimized with respect to that of this composition C1.

It will be noted that the use of 4 pce of a manganese salt constitutes a preferred form according to the invention (see in particular the elongation at break of the composition I4, which is greater than that of the composition C1).

III/ Third Series of Tests:

Again two compositions C1 and C2 as described in § I/ above, three compositions NA6, NA7 and NA8 not in accordance with the invention and a composition I5 according to the invention were prepared. These compositions NA6 to NA8 and I5 are all crosslinked by the same peroxide as the composition C2 and they incorporate, in addition to the ingredients of the composition C2, combinations of organic salts of transition metals as described in § I/ and II/ above and a crosslinking co-agent for increasing the hardness of the compositions.

The respective formulations of these compositions NA6 to NA8 and I5 are shown below, in comparison with that of the composition C2:
NA6=C2+4 pce manganese octoate+0.5 pce zinc octoate+0.5 pce zirconium octoate +2 pce TAC
NA7=C2+4 pce manganese octoate+0.5 pce zinc octoate+1 pce zirconium octoate +2 pce TAC
NA8=C2+4 pce manganese octoate+1 pce zinc octoate+0.5 pce zirconium octoate+2 pce TAC
I5=C2+4 pce manganese octoate+1 pce zinc octoate+1 pce zirconium octoate +2 pce TAC,
with TAC=triallyl cyanurate with the trade name “TAC 70 GR”.

Each crosslinked composition was prepared and analysed as indicated in § I/. The properties obtained in the noncrosslinked state, during the crosslinking and in the crosslinked state for each rubber composition C1, C2, NA6 to NA8 and I5 are recorded in Table 3 below.

TABLE 3

| | C1 | C2 | NA6 | NA7 | NA8 | I5 |
|---|---|---|---|---|---|---|
| ML(1 + 4) | 81.9 | 86.8 | 80.5 | 81.1 | 82.3 | 80.5 |
| t5 scorch (min) | >30 | 10.50 | 17.68 | 16.12 | 15.12 | 17.50 |
| ML (dN.m) | 2.00 | 2.48 | 1.91 | 1.96 | 1.97 | 1.83 |
| MH (dN.m) | 19.73 | 16.69 | 14.86 | 14.64 | 15.10 | 13.48 |
| ΔC (dN.m) | 17.73 | 14.21 | 12.94 | 12.68 | 13.13 | 11.65 |
| t′c(05)(min) | 1.75 | 0.52 | 0.67 | 0.65 | 0.65 | 0.70 |
| t′c(50)(min) | 3.25 | 3.08 | 3.48 | 3.33 | 3.38 | 3.37 |
| t′c(95)(min) | 12.17 | 13.25 | 13.43 | 13.28 | 13.45 | 13.92 |
| Tack | 10 | 0 | 7 | 9 | 8 | 10 |
| Shore A | 68 | 62 | 63 | 62 | 63 | 63 |
| CS (%) | 65 | 16 | 17 | 16 | 15 | 15 |
| SMOE 100 | 3.8 | 2.8 | 3.0 | 2.8 | 2.8 | 2.9 |
| (MPa) | | | | | | |
| SMOE 300 | 8.7 | 8.5 | 9.4 | 8.4 | 8.7 | 9.1 |
| (MPa) | | | | | | |
| BS (MPa) | 9.3 | 8.8 | 9.6 | 9.2 | 9.5 | 9.4 |
| EB (%) | 332 | 309 | 302 | 320 | 318 | 306 |
| Tear strength | 15.37 | 14.00 | 14.03 | 13.69 | 14.11 | 13.64 |
| (N/mm) | | | | | | |

This table shows that at least 2 pce of second organic salts according to the invention (of zinc and of zirconium respectively) are necessary, in combination with 4 pce of a first salt according to the invention (of manganese), to confer, on the section formed from the composition I5, a truly non-tacky surface (level of tack equal to 10), after the fashion of the reference surface which characterizes the section formed from the composition C1 crosslinked with sulphur, while conferring, on this composition I5, a CS which is markedly minimized with respect to that of this composition C1. This is because the compositions not in accordance, NA6 to NA8, characterized by an amount of second organic salts equal to 1 or 1.5 pce, do not make it possible to confer this non-tacky surface on the sections which are formed from them.

It will be noted that the tensile strength properties of this composition I5 according to the invention are satisfactory, being substantially analogous to those of the composition C1 crosslinked with sulphur (see in particular the breaking strength, the elongation at break and the tear strength).

IV/ Fourth Series of Tests:

Again a composition C1 as described in § I/, three compositions NA9, NA10 and NA11 not in accordance with the invention and four compositions I6, I7, I8 and I9 according to the invention were prepared. These compositions NA9 to NA11 and I6 to I9 are all crosslinked by the same peroxide as the composition C2 of § I/ but with various amounts of this peroxide (6, 7 or 8 pce) and they incorporate combinations of organic salts of manganese and of zinc as described in § I/ above and various crosslinking co-agents for increasing the hardness of the compositions.

The respective formulations of these compositions NA9 to NA11 and I6 to I9 are shown below, in comparison with that of the composition C2:
NA9=C2′ (=C2 including 6 pce of “Luperox F 40 MF” instead of 8 pce)+4 pce manganese octoate+2 pce zinc octoate+4 pce TAC
NA10=C2′ (=C2 including 6 pce of “Luperox F 40 MF” instead of 8 pce)+4 pce manganese octoate+2 pce zinc octoate+4 pce Pertac
NA11=C2′ (=C2 including 6 pce of “Luperox F 40 MF” instead of 8 pce)+4 pce manganese octoate+2 pce zinc octoate+4 pce TMPTMA 70
I6=C2′ (=C2 including 7 pce of “Luperox F 40 MF” instead of 8 pce)+4 pce manganese octoate+2 pce zinc octoate+4 pce TAC
I7=C2 (including 8 pce of “Luperox F 40 MF” as indicated in § I/)+4 pce manganese octoate+2 pce zinc octoate+4 pce TAC
I8=C2 (including 8 pce of “Luperox F 40 MF” as indicated in § I/) +4 pce manganese octoate+2 pce zinc octoate+4 pce Pertac
I9=C2 (including 8 pce of “Luperox F 40 MF” as indicated in § I/)+4 pce manganese octoate+2 pce zinc octoate+4 pce TMPTMA 70 with
TAC=triallyl cyanurate with the name “TAC 70 GR”, “Pertac”=trade name of a polymer of 1,2-polybutadiene type, and
“TMPTMA 70″=trimethylolpropane trimethacrylate.

Each crosslinked composition was prepared and analysed as indicated in § I/. The properties obtained in the noncrosslinked state, during the crosslinking and in the crosslinked state for each rubber composition C1, NA9 to NA11 and I6 to I8 are recorded in Table 4 below.

TABLE 4

| | C1 | NA9 | NA10 | NA11 | I6 | I7 | I8 | I9 |
|---|---|---|---|---|---|---|---|---|
| ML(1 + 4) | 84.8 | 77.1 | 80.3 | 77.7 | 77.1 | 77.4 | 79.9 | 78.3 |
| t5 scorch | 27.03 | 22.55 | 15.45 | 10.08 | 22.45 | 22.25 | 11.98 | 9.42 |
| (min) | | | | | | | | |
| ML (dN.m) | 2.13 | 1.80 | 1.96 | 1.88 | 1.83 | 1.89 | 1.93 | 1.97 |
| MH (dN.m) | 20.12 | 14.85 | 13.02 | 15.99 | 16.92 | 20.53 | 14.63 | 18.30 |
| ΔC (dN.m) | 17.99 | 13.04 | 11.06 | 14.11 | 15.08 | 18.64 | 12.70 | 16.33 |
| T′c(05)(min) | 1.82 | 2.75 | 0.68 | 0.53 | 0.77 | 0.72 | 0.63 | 0.48 |
| T′c(50)(min) | 3.33 | 8.55 | 3.47 | 2.37 | 3.93 | 3.82 | 3.28 | 2.13 |
| T′c(95)(min) | 11.20 | 14.32 | 13.37 | 11.22 | 14.58 | 14.67 | 13.67 | 12.58 |
| Tack | 10 | 9 | 9 | 9 | 10 | 10 | 10 | 10 |
| Shore A | 66 | 60 | 58 | 59 | 62 | 64 | 61 | 62 |
| CS (%) | 76 | 20 | 29 | 27 | 17 | 14 | 20 | 19 |
| SMOE 100 | 4.0 | 2.3 | 2.1 | 2.6 | 3.2 | 3.3 | 2.5 | 3.0 |
| (MPa) | | | | | | | | |
| SMOE 300 | 8.9 | 7.3 | 6.7 | 7.9 | — | — | 8.3 | 5.8 |
| (MPa) | | | | | | | | |
| BS (MPa) | 9.5 | 8.3 | 8.0 | 8.9 | 9.6 | 10.0 | 9.2 | 9.4 |
| EB (%) | 322 | 334 | 376 | 325 | 268 | 268 | 322 | 286 |
| Tear strength | 14.59 | 12.86 | 12.83 | 13.10 | 12.00 | 12.13 | 12.68 | 13.05 |
| (N/mm) | | | | | | | | |

This table shows in particular that an amount of organic peroxide at least equal to 7 pce, in combination with 4 pce of a first salt and 2 pce of a second salt according to the invention (of manganese and of zinc, respectively), makes it possible to confer, on the section formed from the compositions I6 to I9, a truly non-tacky surface (level of tack equal to 10), after the fashion of the reference surface which characterizes the section formed from the composition C1 crosslinked with sulphur, while conferring, on these compositions I6 to I9, a CS which is markedly minimized with respect to that of this composition C1. This is because the compositions not in accordance, NA9 to NA11, characterized by an amount of organic peroxide of only 6 pce, confer only a virtually non-tacky surface (level of tack equal to 9) on the sections which are formed from them.

This table also shows that the preferred co-agents according to the invention for the improvement in the mechanical properties and in particular in the Shore A hardness are TAC and TMPTMA.

V/ Fifth Series of Tests:

Again two compositions C1 and C2 as described in § I/ and four compositions I10, I1, I12 and I13 according to the invention were prepared. These compositions I10 to I13 are all crosslinked by the same peroxide as the composition C2 of § I/ with various amounts of this peroxide (7 or 8 pce) and they incorporate combinations of organic salts of manganese and of zinc as described in § I/ above and optionally a mixture according to various amounts of “TAC 70 GR” and of “TMPTMA 70” as crosslinking co-agents for increasing the hardness of the compositions.

After the fashion of the compositions forming the subject of § I/ to IV/, these compositions are suitable for a sealing strip for a motor vehicle door seal. The respective formulations of these compositions I10 to I13 are shown below, in comparison with that of the composition C2:
I10=C2 (including 8 pce of “Luperox F 40 MF” as indicated in § I/)+4 pce manganese octoate+2 pce zinc octoate
I11=C2 (including 8 pce of “Luperox F 40 MF” as indicated in § I/)+4 pce manganese octoate+2 pce zinc octoate+2 pce TMPTMA+2 pce TAC
I12=C2 (including 8 pce of “Luperox F 40 MF” as indicated in § I/)+4 pce manganese octoate+2 pce zinc octoate+2 pce TMPTMA+3 pce TAC
I13=C2″ (=C2 including 7 pce of “Luperox F 40 MF” instead of 8 pce)+4 pce manganese octoate+2 pce zinc octoate+2 pce TMPTMA+3 pce TAC.

Each crosslinked composition was prepared and analysed as indicated in § I/. The properties obtained in the noncrosslinked state, during the crosslinking and in the crosslinked state for each rubber composition C1, C2 and I10 to I13 are recorded in Table 5 below.

TABLE 5

| | C1 | C2 | I10 | I11 | I12 | I13 |
|---|---|---|---|---|---|---|
| ML(1 + 4) | 78.5 | 83.8 | 77.5 | 75.3 | 74.7 | 74.7 |
| t5 scorch (min) | 28.03 | 10.77 | 11.03 | 10.33 | 8.90 | 9.28 |
| ML (dN.m) | 2.04 | 2.44 | 1.99 | 1.94 | 1.92 | 1.94 |
| MH (dN.m) | 19.45 | 16.14 | 10.03 | 20.02 | 20.22 | 18.77 |
| ΔC (dN.m) | 17.41 | 13.70 | 8.04 | 18.08 | 18.30 | 16.83 |
| t′c(05)(min) | 1.77 | 0.50 | 0.57 | 0.53 | 0.50 | 0.52 |
| t′c(50)(min) | 3.22 | 2.97 | 3.37 | 2.75 | 2.55 | 2.58 |
| t′c(95)(min) | 11.25 | 12.67 | 14.55 | 14.30 | 13.90 | 13.97 |
| Tack | 10 | 0 | 10 | 10 | 10 | 10 |
| Shore A | 69 | 63 | 60 | 64 | 65 | 64 |
| CS (%) | 52 | 17 | 18 | 15 | 14 | 16 |
| SMOE 100 | 3.9 | 2.8 | 2.3 | 2.9 | 3.2 | 2.8 |
| (MPa) | | | | | | |
| SMOE 300 | 9.4 | 8.5 | 7.2 | — | — | — |
| (MPa) | | | | | | |
| BS (MPa) | 10.1 | 8.8 | 9.1 | 9.7 | 9.4 | 9.1 |
| EB (%) | 329 | 301 | 369 | 273 | 262 | 286 |
| Tear strength | 13.93 | 13.07 | 13.57 | 11.59 | 12.74 | 12.00 |
| (N/mm) | | | | | | |

This table shows in particular that an amount of organic peroxide at least equal to 7 pce, in combination with 4 pce of a first salt and 2 pce of a second salt according to the invention (of manganese and of zinc respectively), makes it possible to confer, on the section formed from the compositions I10 to I13, a truly non-tacky surface, after the fashion of the surface which characterizes the section formed from the composition C1, while conferring, on these compositions I10 to I13, a CS which is markedly minimized with respect to that of this composition Cl. This table also shows that the mixture of the two co-agents TAC and TMPTMA makes it possible to substantially increase the Shore A hardness of the compositions I11 to I13 in comparison with the composition I10, which does not comprise co-agent, while conferring satisfactory tensile strength properties (see in particular the elongation at break).

VI/ Sixth Series of Tests:

Two new “control” rubber compositions C3 and C4, which are respectively crosslinked with sulphur and by another organic peroxide, and a new rubber composition I14 according to the invention, also crosslinked by this new peroxide, were prepared. These compositions are suitable for forming a sealing strip for the building industry.

The compositions C3 and C4 each exhibit the following formulation (expressed in pce: parts by weight per 100 parts of elastomer):

| | |
|---|---|
| Elastomer (1) | 100.00 |
| Carbon black | 170.00 |
| Diluting light-coloured filler | 40.00 |
| Paraffin plasticizer | 108.00 |
| Stearic acid | 1.00 |
| Drying agent (2) | 6.40 |
| Crosslinking system (3) | variable |

with
(1) = terpolymer of ethylene, of propylene and of
ethylidenenorbornene (EPDM), the level by weight of
propylene of which is 40%;
(2): calcium oxide on support; and
(3): for the composition C3:
a sulphur crosslinking system comprising (pce):

| | |
|---|---|
| Zinc oxide | 2.50 |
| 80% Dithiodimorpholine | 1.90 |
| Tetramethylthiuram monosulphide | 1.70 |
| Mercaptobenzothiazole | 0.85 |
| Sulphur, 120 mesh | 1.30 |

for the composition C4:
a peroxide crosslinking system comprising 8 pce of
“Perkadox 1440 B GR”, i.e. a dispersion comprising
40% by weight of di(2-tert-butylisopropyl)benzene
peroxide as active product.

The composition I14 according to the invention differs from the composition C4 crosslinked with peroxide only in that it additionally comprises 4 pce of manganese octoate combined in situ with 2 pce of zinc octoate, as described in § I/ above.

Each crosslinked composition C3, C4 and I14 was prepared and analysed as indicated in § I/ above. The properties obtained in the noncrosslinked state, during the crosslinking and in the crosslinked state for each rubber composition C3, C4 and I14 are recorded in Table 6 below.

TABLE 6

| | C3 | C4 | I14 |
|---|---|---|---|
| ML(1 + 4) | 58.0 | 60.0 | 58.0 |
| t5 scorch (min) | 17.78 | 22.53 | >30 |
| ML (dN · m) | 2.23 | 2.09 | 1.77 |
| MH (dN · m) | 13.24 | 9.69 | 7.65 |
| ΔC (dN · m) | 11.01 | 7.60 | 5.88 |
| t′c(05)(min) | 1.92 | 0.60 | 0.70 |
| t′c(50)(min) | 3.58 | 4.37 | 3.62 |
| t′c(95)(min) | 6.43 | 16.43 | 12.05 |
| Tack | 8 | 0 | 9 |
| Density | 1.22 | 1.21 | 1.21 |
| Shore A | 66 | 54 | 55 |
| CS (%) | 50 | 17 | 27 |
| SMOE 100 (MPa) | 3.9 | 2.1 | 1.7 |
| SMOE 300 (MPa) | 9.8 | 5.7 | 4.4 |
| BS (MPa) | 9.8 | 5.9 | 5.1 |
| EB (%) | 308 | 316 | 366 |
| Tear strength (N/mm) | 12.83 | 14.59 | 12.86 |

This table shows that the combination of the first and 5 second salts according to the invention in combination with di(2-tert-butylisopropyl)benzene peroxide, in place of the 1,3-1,4-bis(tert-butylperoxyisopropyl)-benzene used in § I/ to V/ above, with an elastomer matrix formed from another EPDM than those used above, confers, on the section formed from the composition I14, a virtually non-tacky surface (level of tack equal to 9), after the fashion of the surface which characterizes the section formed from the composition C3 crosslinked with sulphur (level of tack equal to 8), while conferring, on this composition I14, a CS which is markedly minimized with respect to that of this composition C3 and which is similar to that of the composition C4 crosslinked with peroxide.

It will also be noted that the tensile strength properties of this composition I14 according to the invention are satisfactory, being analogous to or better than those of the composition C3 (see in particular the elongation at break and the tear strength, which are improved).

VII/ Seventh Series of Tests:

Again compositions C3 and C4 as described in § VI/ above and a new composition I15 according to the invention, which differs from the composition I14 of § VI/ only in that it additionally comprises a mixture of crosslinking co-agents for increasing the hardness of the composition, were prepared.

The mixture of co-agents is composed of 4 pce of “TAC 70 GR” and of 2 pce of “TMPTA 70” , as are defined above.

Each crosslinked composition C3, C4 and I15 was prepared and analysed as indicated in § I/ above. The properties obtained in the noncrosslinked state, during the crosslinking and in the crosslinked state for each rubber composition C3, C4 and I15 are recorded in Table 7 below.

TABLE 7

| | C3 | C4 | I15 |
|---|---|---|---|
| ML(1 + 4) | 60.0 | 61.0 | 58.0 |
| t5 scorch (min) | 17.62 | 11.42 | 11.75 |
| ML (dN · m) | 2.27 | 2.25 | 1.75 |
| MH (dN · m) | 12.35 | 7.73 | 11.48 |
| ΔC (dN · m) | 10.08 | 5.48 | 9.74 |
| t′c(05)(min) | 1.43 | 0.50 | 0.60 |
| t′c(50)(min) | 2.47 | 2.92 | 2.45 |
| t′c(95)(min) | 4.85 | 13.57 | 10.17 |
| Tack | 8 | 0 | 10 |
| Density | 1.22 | 1.27 | 1.21 |
| Shore A | 66 | 52 | 59 |
| CS (%) | 59 | 29 | 25 |
| SMOE 100 (MPa) | 3.3 | 1.6 | 2.3 |
| SMOE 300 (MPa) | 8.5 | 2.9 | 5.7 |
| BS (MPa) | 8.8 | 2.9 | 5.7 |
| EB (%) | 322 | 294 | 301 |
| Tear strength (N/mm) | 16.00 | 10.00 | 12.00 |

This table shows that the incorporation of a mixture of co-agents TAC and TMPTMA in the composition I15 comprising the combination of the first and second salts according to the invention in combination with di(2-tert-butylisopropyl)benzene peroxide confers, on the section formed from the composition I15, a truly non-tacky surface (level of tack equal to 10) in comparison with that, somewhat tacky, which characterizes the section formed from the composition C3 (level of tack equal to 8), while conferring, on this composition I15, a CS which is markedly minimized with respect to that of this composition C3 and even less than that of the composition C4 crosslinked with peroxide.

It will also be noted that the hardness and elongation at break properties of this composition I15 according to the invention are satisfactory, being markedly better than those of the composition C4 and substantially analogous to those of the composition C3.

VIII/ Eighth Series of Tests:

Again a composition C3 as described in § VI/ above, two new “control” compositions C4′ and C4″, differing from the composition C4 only in the nature of the peroxide used, and two new compositions I16 and I17 according to the invention, which differ from the composition I15 only in the nature of this peroxide, were prepared.

More specifically, the composition C4′ incorporates 8 pce of a dispersion sold under the name “Dicup 40C” comprising 40% by weight of a dicumyl peroxide as active product.

The composition C4″ incorporates 8 pce of a dispersion sold under the name “Trigonox 29/40 MB”, i.e. comprising 40% by weight of 1,1-di(tert-butylperoxy)-3,3,5-trimethylcyclohexane as active product.

The composition I16 differs from the composition C4′ only in that it additionally comprises, like the composition I15, on the one hand, 4 pce of manganese octoate combined with 2 pce of zinc octoate and, on the other hand, the abovementioned mixture of co-agents TAC (4 pce) and TMPTMA (2 pce).

The composition I17 differs from the composition C4′ only in that it additionally comprises, like the composition I15, on the one hand, 4 pce of manganese octoate combined with 2 pce of zinc octoate and, on the other hand, the abovementioned mixture of co-agents TAC (4 pce) and TMPTMA (2 pce).

Each crosslinked composition C3, C4′, C4″, I16 and I17 was prepared and analysed as indicated in § I/ above.

The properties obtained in the noncrosslinked state, during the crosslinking and in the crosslinked state for each rubber composition are recorded in Table 8 below.

TABLE 8

| | C3 | C4′ | C4″ | I16 | I17 |
|---|---|---|---|---|---|
| ML(1 + 4) | 65.2 | 61.5 | 65.0 | 58.6 | 57.4 |
| t5 scorch (min) | 15.98 | 12.93 | 4.07 | 11.25 | 3.67 |
| ML (dN.m) | 2.40 | 2.37 | 2.46 | 1.8 | 2.12 |
| MH (dN.m) | 14.09 | 5.97 | 5.09 | 8.97 | 8.45 |
| ΔC (dN.m) | 11.69 | 3.60 | 2.63 | 7.17 | 6.33 |
| t′c(05)(min) | 1.58 | 0.42 | 0.22 | 0.53 | 0.25 |
| t′c(50)(min) | 3.02 | 1.70 | 0.40 | 1.78 | 0.45 |
| t′c(95)(min) | 5.83 | 6.22 | 0.85 | 5.75 | 0.97 |
| Tack | 8 | 0 | 0 | 10 | 10 |
| Density | 1.22 | 1.21 | 1.21 | 1.21 | 1.21 |
| Shore A | 70 | 49 | 45 | 54 | 52 |
| CS (%) | — | — | — | — | — |
| SMOE 100 (MPa) | 4.3 | 1.3 | 1.1 | 1.7 | 1.6 |
| SMOE 300 (MPa) | 8.9 | — | — | 4.0 | 4.3 |
| BS (MPa) | 10.3 | 1.6 | 1.2 | 4.6 | 4.8 |
| EB (%) | 288 | 206 | 137 | 361 | 353 |
| Tear strength (N/mm) | 18.64 | 6.62 | 5.64 | 10.47 | 11.56 |

This table shows that the incorporation of a TAC-TMPTMA mixture in one or other of the compositions I16 and I17 comprising the first and second salts according to the invention in combination with dicumyl peroxide or with 1,1-di(tert-butylperoxy)-3,3,5-trimethylcyclohexane confers, on the section formed from the composition I16 or I17, a truly non-tacky surface in comparison with that, somewhat tacky, which characterizes the section formed from the composition C3 crosslinked with sulphur, while conferring, on these compositions I16 and I17, an acceptable hardness and an elongation at break which is markedly improved with respect to that of this composition C3.

IX/ Ninth Series of Tests:

Two new “control” rubber compositions C5 and C6, which are respectively crosslinked with sulphur and by an organic peroxide, and a new rubber composition I18 according to the invention, also crosslinked by this peroxide, were prepared.

The compositions C5 and C6 each exhibit the following formulation (expressed in pce: parts by weight per 100 parts of elastomer):

| | |
|---|---|
| Elastomer (1) | 100.00 |
| Carbon black | 170.00 |
| Diluting light-coloured filler | 40.00 |
| Paraffin plasticizer | 108.00 |
| Stearic acid | 1.00 |
| Drying agent (2) | 3.80 |
| Crosslinking system (3) | variable |

with
(1) = based on a terpolymer of ethylene, of propylene
and of ethylidenenorbornene (EPDM), the levels by
weight of ethylene and of ethylidenenorbornene of which
are respectively 67% and 4.9%;
(2): calcium oxide on support; and
(3): for the composition C5:
a sulphur crosslinking system comprising (pce):

| | |
|---|---|
| Zinc oxide | 2.50 |
| 80% Dithiodimorpholine | 1.90 |
| Tetramethylthiuram monosulphide | 1.70 |
| Mercaptobenzothiazole | 0.85 |
| Sulphur, 120 mesh | 1.30 |

for the composition C6:
a peroxide crosslinking system comprising 8 pce of
“Perkadox 1440 B GR” as organic peroxide.

The composition I18 according to the invention differs from the composition C6 crosslinked with peroxide only in that it additionally comprises 4 pce of manganese octoate combined with 2 pce of zinc octoate, as are described in § I/ above.

Each crosslinked composition C5, C6 and I18 was prepared and analysed as indicated in § I/ above. The properties obtained in the noncrosslinked state, during the crosslinking and in the crosslinked state for each 10 rubber composition C5, C6 and I18 are recorded in Table 9 below.

TABLE 9

| | C5 | C6 | I18 |
|---|---|---|---|
| ML(1 + 4) | 77.0 | 73.0 | 76.0 |
| t5 scorch (min) | 16.00 | 10.78 | 5.23 |
| ML (dN · m) | 5.66 | 5.08 | 4.31 |
| MH (dN · m) | 16.64 | 15.12 | 12.23 |
| ΔC (dN · m) | 10.98 | 10.04 | 7.92 |
| t′c(05)(min) | 1.62 | 0.47 | 0.43 |
| t′c(50)(min) | 3.02 | 3.50 | 2.65 |
| t′c(95)(min) | 5.25 | 14.20 | 9.88 |
| Tack | 9 | 5 | 9 |
| Density | 1.27 | 1.26 | 1.26 |
| Shore A | 77 | 73 | 71 |
| CS (%) | 60 | 18 | 22 |
| SMOE 100 (MPa) | 6.3 | 3.3 | 3.1 |
| SMOE 300 (MPa) | — | — | — |
| BS (MPa) | 9.6 | 5.4 | 5.3 |
| EB (%) | 151 | 180 | 211 |
| Tear strength (N/mm) | 12.92 | 13.10 | 12.00 |

This table shows that the combination of the first and second salts according to the invention in combination with di(2-tert-butylisopropyl)benzene peroxide, with an elastomer matrix formed from another EPDM than those used above, confers, on the section formed from the composition I18, a virtually non-tacky surface (level of tack equal to 9), after the fashion of the surface which characterizes the section formed from the composition CS crosslinked with sulphur, while conferring, on this composition I18, a CS which is markedly minimized with respect to that of this composition C5 and which is similar to that of the composition C6 crosslinked with peroxide.

It will also be noted that the hardness and elongation at break qualities of this composition I18 according to the invention are satisfactory, being analogous to or better than those of the composition CS.

X/ Tenth Series of Tests:

Again compositions CS and C6 as described in § IX/ above and a new composition I19 according to the invention, which differs from the composition I18 of § IX/ only in that it additionally comprises a mixture of the said crosslinking co-agents TAC and TMPTMA for increasing the hardness of the composition, were prepared.

As above, the mixture of co-agents is composed of 4 pce of “TAC 70 GR” and of 2 pce of “TMPTA 70”.

Each crosslinked composition CS, C6 and I19 was prepared and analysed as indicated in § I/ above. The properties obtained in the noncrosslinked state, during the crosslinking and in the crosslinked state for each rubber composition CS, C6 and I19 are recorded in Table 10 below.

TABLE 10

| | C5 | C6 | I19 |
|---|---|---|---|
| ML(1 + 4) | 89.0 | 85.0 | 79.0 |
| t5 scorch (min) | 13.47 | 6.70 | 6.27 |
| ML (dN · m) | 5.17 | 6.81 | 3.88 |
| MH (dN · m) | 17.19 | 14.00 | 14.31 |
| ΔC (dN · m) | 12.02 | 7.19 | 10.43 |
| t′c(05)(min) | 1.38 | 0.50 | 0.45 |
| t′c(50)(min) | 2.53 | 2.65 | 2.47 |
| t′c(95)(min) | 6.10 | 11.25 | 9.47 |
| Tack | 9 | 0 | 10 |
| Density | 1.26 | 1.26 | 1.26 |
| Shore A | 76 | 63 | 72 |
| CS (%) | 62 | 27 | 27 |
| SMOE 100 (MPa) | 6.2 | 3.0 | 3.0 |
| SMOE 300 (MPa) | — | — | — |
| BS (MPa) | 9.8 | 4.6 | 5.0 |
| EB (%) | 163 | 215 | 153 |
| Tear strength (N/mm) | 12 | 10 | 10 |

This table shows that the incorporation of a mixture of co-agents TAC and TMPTMA in the composition I19 comprising the combination of the first and second salts according to the invention in combination with di(2-tert-butylisopropyl)benzene peroxide confers, on the section formed from the composition I19, a truly non-tacky surface (level of tack equal to 10) in comparison with that, somewhat tacky, which characterizes the section formed from the composition CS (level of tack equal to 9), while conferring, on this composition I19, a CS which is markedly minimized with respect to that of this composition CS.

It will also be noted that the hardness and elongation at break properties of this composition I19 according to the invention are satisfactory, being substantially analogous to those of the composition CS.

X1/ Eleventh Series of Tests:

A new “control” rubber composition C7, which is crosslinked by an organic peroxide, and a new rubber composition I20 according to the invention, also crosslinked by this peroxide, were prepared.

The composition C7 exhibits the following formulation (expressed in pce: parts by weight per 100 parts of elastomer):

| | |
|---|---|
| Elastomer (1) | 100.00 |
| Carbon black | 160.00 |
| Diluting light-coloured filler | 50.00 |
| Paraffin plasticizer | 105.00 |
| Drying agent (2) | 7.00 |
| 70% Triallyl cyanurate (3) | 3.00 |
| Organic peroxide (4) | 8.00 |

with
(1) = based on a terpolymer of ethylene, of propylene and of ethylidenenorbornene (EPDM), the level by weight of propylene of which is 40%;
(2): calcium oxide on a support;
(3): TAC with the name “TAC 70 GR”; and
(4): abovementioned peroxide with the name “Perkadox 1440 B GR”.

The composition I20 according to the invention differs from the composition C7 only in that it additionally comprises 4 pce of manganese octoate combined with 2 pce of zinc octoate, as are described in § I/ above.

Each crosslinked composition C7 and I20 was prepared and analysed as indicated in § I/ above. The properties obtained in the noncrosslinked state, during the crosslinking and in the crosslinked state for each rubber composition C7 and I20 are recorded in Table 11 below.

TABLE 11

| | C7 | I20 |
|---|---|---|
| ML(1 + 4) | 50.0 | 53.0 |
| t5 scorch (min) | 15.68 | 23.28 |
| ML (dN · m) | 1.99 | 1.90 |
| MH (dN · m) | 17.19 | 15.75 |
| ΔC (dN · m) | 15.20 | 13.85 |
| t′c(05)(min) | 0.55 | 0.57 |
| t′c(50)(min) | 3.90 | 3.37 |
| t′c(95)(min) | 15.83 | 14.20 |
| Tack | 5 | 8 |
| Density | 1.23 | 1.23 |
| Shore A | 66 | 66 |
| CS (%) | 5 | 7 |
| SMOE 100 (MPa) | 4.0 | 3.6 |
| SMOE 300 (MPa) | — | — |
| BS (MPa) | 8.3 | 7.9 |
| EB (%) | 205 | 213 |
| Tear strength (N/mm) | 12.82 | 12.13 |

This table shows that the combination of salts according to the invention in combination with di(2-tert-butylisopropyl)benzene peroxide, with an elastomer matrix formed from another EPDM, confers, on the section formed from the composition I20, a virtually non-tacky surface (level of tack equal to 8), in contrast to the surface of the section formed from the composition C7 crosslinked with peroxide, while conferring, on the composition I20, a much reduced CS which is similar to that of this composition C7.

It will also be noted that the hardness and elongation at break properties of this composition I20 according to the invention are satisfactory.

XII/ Twelfth Series of tests:

Again a composition C7 as described in § XI/ above and a new composition I21 according to the invention, which differs from the composition I20 of § XI/ only in that it additionally comprises the said crosslinking co-agent TAC according to an amount of 3 pce, were prepared.

Each crosslinked composition C7 and I21 was prepared and analysed as indicated in § I/ above. The properties obtained in the noncrosslinked state, during the crosslinking and in the crosslinked state for each rubber composition C7 and I21 are recorded in Table 12 below.

TABLE 12

| | C7 | I21 |
|---|---|---|
| ML(1 + 4) | 50.0 | 52.0 |
| t5 scorch (min) | 10.73 | 16.60 |
| ML (dN · m) | 2.03 | 1.75 |
| MH (dN · m) | 17.47 | 15.84 |
| ΔC (dN · m) | 15.44 | 14.09 |
| t′c(05)(min) | 0.55 | 0.57 |
| t′c(50)(min) | 3.82 | 3.27 |
| t′c(95)(min) | 15.77 | 12.97 |
| Tack | 0 | 10 |
| Density | 1.23 | 1.23 |
| Shore A | 63 | 62 |
| CS (%) | 10 | 11 |
| SMOE 100 (MPa) | 4.3 | 3.5 |
| SMOE 300 (MPa) | — | — |
| BS (MPa) | 7.5 | 7.7 |
| EB (%) | 181 | 218 |
| Tear strength (N/mm) | 12.50 | 12.50 |

This table also shows that the combination of the salts according to the invention in combination with di(2-tert-butylisopropyl)benzene peroxide confers, on the section formed from the composition I21, a truly non-tacky surface (level of tack equal to 10), in contrast to the surface of the section formed from the composition C7, while conferring, on this composition I21, a greatly reduced CS which is similar to that of this composition C7.

In conclusion, it will be noted that the compositions I1 to I21 according to the invention can be used to form non-tacky sealing strips, for example for motor vehicles or for the building industry, which exhibit a reduced CS in comparison with that of the known strips with the same dimensions which are crosslinked with sulphur or, in other words, which exhibit reduced dimensions in comparison with those of these strips crosslinked with sulphur for the achievement of the same predetermined CS.

In addition, it will be noted that the rubber compositions obtained in these implementational examples of the invention are devoid of any volatile organic compound or solvent which is potentially toxic and which is capable of generating bubbles in the crosslinked compositions, in contrast to the compositions of reduced tack tested in the abovementioned document U.S. Pat. No. 4 334 043 of the prior state of the art.

1. A crosslinkable or crosslinked rubber composition which is usable to form, in the crosslinked state, a sealing strip exhibiting a non-tacky surface and a reduced compression set, said composition comprising at least one elastomer and a crosslinking system comprising
at least one organic peroxide,
at least one first organic salt of at least one transition metal chosen from the group consisting of manganese, iron, cerium and vanadium, in an amount equal to or greater than 2 parts by weight per 100 parts of elastomer(s), and
at least one second organic salt of at least one other metal chosen from the group consisting of zinc, zirconium, lithium, calcium and barium, in an amount equal to or greater than 2 parts by weight per 100 parts of elastomer(s).

2. The composition according to claim 1, wherein said organic peroxide is present in an amount of active product equal to or greater than 2.8 parts by weight per 100 parts of elastomer(s), the peroxide corresponding to the general formula ROOR in which R is an aliphatic hydrocarbon radical, an alicyclic hydrocarbon radical or an aromatic hydrocarbon radical which is unsubstituted or substituted.

3. The composition according to claim 1 wherein the at least one first salt and the at least one second salt are each independently a salt of a monocarboxylic or dicarboxylic acid of unsaturated or saturated aliphatic type, of alicyclic type or of aromatic type comprising one or more unsubstituted or substituted aromatic rings.

4. The composition according to claim 3, wherein the at least one first salt and/or the at least one second salt result from identical or different saturated aliphatic monocarboxylic acids

5. The composition according to claim 4, wherein the at least one first salt and/or the at least one second salt result from 2-ethylhexanoic acid.

6. The composition according to claim 3, wherein the at least one first salt and/or the at least one second salt result from identical or different monocarboxylic acids of alicyclic type.

7. The composition according to claim 1 comprising a manganese salt as said at least one first salt.

8. The composition according to claim 1 comprising a zinc salt and/or a zirconium salt as said at least one second salt.

9. The composition according to claim 7 comprising manganese 2-ethylhexanoate, and a zinc salt.

10. The composition according to claim 1 wherein the said first salt(s) are in an amount equal to or greater than 4 parts by weight per 100 parts of elastomer(s) and the said second salt(s) are in an amount equal to or greater than 3 parts by weight per 100 parts of elastomer(s).

11. The composition according to claim 10, comprising manganese 2-ethylhexanoate in an amount ranging from 4 to 8 parts by weight per 100 parts of elastomer(s) and zinc 2-ethylhexanoate in an amount ranging from 3 to 6 parts by weight per 100 parts of elastomer(s).

12. The composition according to claim 1 wherein the said or one at least of the said elastomer(s) is a terpolymer of ethylene, of propylene and of a diene.

13. The composition according to claim 12, wherein said crosslinking system additionally comprises triallyl cyanurate in an amount ranging from 2 to 4 parts by weight per 100 parts of elastomer(s) and trimethylolpropane trimethacrylate in an amount ranging from 1 to 3 parts by weight per 100 parts of elastomer(s).

14. The composition according to claim 1 comprising a reinforcing filler based on a carbon black in an amount of greater than 100 parts by weight per 100 parts of elastomer(s).

15. The composition according to claim 1 which exhibits, in the crosslinked state, a compression set (CS in %), measured according to Standard NF T46-01 1, which is less than or equal to 30%.

16. A process for the preparation of a rubber composition according to claim 1 comprising the incorporation in the said crosslinkable composition of the said first and second salt(s) by mechanical working, followed by crosslinking the said composition with hot air.

17. A process according to claim 16, comprising the in situ mixing of the said first and second salt(s) during their incorporation in the said crosslinkable composition.

18. A sealing strip which is usable for the insulation of buildings or motor vehicles, formed from a rubber composition according to claim 1.
